(19) United States
(12) Patent Application Publication
(10) Pub. No.: US 2024/0076220 A1
(43) Pub. Date: Mar. 7, 2024

(54) Method of Wastewater Treatment and Apparatus for its Realization

(71) Applicant: Jan TOPOL, Prague 8 (CZ)

(72) Inventor: Jan TOPOL, Prague 8 (CZ)

(21) Appl. No.: 18/241,329

(22) Filed: Sep. 1, 2023

(30) Foreign Application Priority Data
Sep. 7, 2022 (CZ) PV 2022-380

(51) Int. Cl. C02F 3/12

(52) U.S. Cl. CPC C02F 3/1205; C02F 3/1278; C02F 2209/42

(57) ABSTRACT

In a method for treating wastewater and an associated design of a treatment plant, wastewater in a storage tank is filled from a minimum level to a maximum level. While being filled, a bioreactor is aerated. After subsequent sedimentation of activated sludge at the bottom of the bioreactor, treated water is pumped from a subsurface layer in the bioreactor and wastewater is simultaneously fed from the storage tank into a sludge bed in the bioreactor. When a level of wastewater in the storage tank is lowered to the minimum level, pumping of treated water from the bioreactor and pumping of wastewater into the bioreactor simultaneously stops. The storage tank has a wastewater pump leading to the bottom of the bioreactor. A safety overflow in the bioreactor leads to a treated water drain having a treated water pump.

### CROSS REFERENCE TO RELATED APPLICATION

This patent application claims the benefit of and priority to Czech Republic Patent Application No. PV 2022-380, filed on Sep. 7, 2022, the disclosure of which is incorporated by reference herein in its entirety as part of the present disclosure.

### FIELD

The invention relates to a method for treating municipal wastewater based on the discontinuous treatment principle for application in a domestic biological treatment plant.

### BACKGROUND

Two methods of separating activated sludge from the treated water are mainly used in practice for wastewater treatment with activated sludge in a buoyancy tank.

The first method consists in the continuous flow of treated water through the activation tank, where the activated sludge mixture, together with the treated water, is continuously fed into a separate settling tank. The sludge, which is heavier than water, settles at the bottom of the tank and is returned to the activation tank. The treated water flows from the surface of the settling tank into the outlet of the treatment plant.

The second “SBR” (Sequencing Batch Reactor) system method, with discontinuous flow through the activation tank, uses intermittent activation to settle the sludge at the bottom of the activation tank, and the clean water is then pumped from the subsurface in the bioreactor to the outlet. The activation tank is then refilled with wastewater for further activation.

The main disadvantage of known discontinuous SBR systems is the method of pumping out the treated water, which lowers the level of the pumped water in the reactor. Various “decanter” designs are known, which are lowered into the water or kept afloat by floats, or submersible pumps on floats and other solutions are used. A common problem with these decanters is that sludge is not allowed to enter the decanter during the aeration of the bioreactor, which leads to structural complexity of the decanter and often problematic water quality at the outlet of the treatment plant. A further problem is caused by the gradual descent of the decanting equipment, together with the falling level of the treated water pumped from the subsurface, which thus approaches the sludge contaminated area. This also leads to the already described negative consequences concerning the design complexity of the decanter and the quality of the treated water.

### SUMMARY

The abovementioned shortcomings are eliminated by the method of wastewater treatment according to the invention. The wastewater is filled from the minimum level to the maximum level in the storage tank, while the bioreactor is aerated during the filling of the storage tank. Once the storage tank is filled, aeration of the bioreactor stops. After subsequent sedimentation of the activated sludge at the bottom of the bioreactor, treated water is pumped from the subsurface layer in the bioreactor and wastewater is simultaneously fed from the storage tank into the sludge layer in the bioreactor. This ensures a constant water level in the bioreactor throughout the bioreactor pumping period. When the water level in the storage tank is lowered to the minimum level, both the pumping of treated wastewater from the treatment plant and the pumping of wastewater to the bioreactor are stopped at the same time. The storage tank then starts to fill with wastewater again and the bioreactor starts to aerate. The aeration of the bioreactor during the filling of the storage tank may be continuous or intermittent, or alternate with the mixing of the wastewater with the sludge. During the aeration of the bioreactor the wastewater in the filling storage tank can also be aerated.

A domestic biological wastewater treatment plant should comprise at least two separate tanks of any shape; a storage tank with an inflow of wastewater and a bioreactor equipped with an aeration device. The treatment plant may also include a sludge tank. The storage tank is equipped with a wastewater pump to the bioreactor, a measuring device for detecting the minimum and the maximum level, and a safety overflow, with a pre-set boom, for the bioreactor. This overflow is connected via a connecting pipe with a vertical pipe to the bottom of the bioreactor. The bioreactor is also equipped with a treated water pump and a safety overflow with a pre-set boom, flowing into the drain from the treatment plant. The hydraulic capacities of the wastewater pump for pumping wastewater into the bioreactor and the treated water pump for pumping the treated water out of the treatment plant are set to maintain a stable water level in the bioreactor. As a result, the inflow of the treated water pump can be installed at a constant shallow depth below the water level in the bioreactor.

The invention's solution combines both the above-described methods of continuous and discontinuous wastewater treatment. The invention uses a discontinuous method while advantageously maintaining a constant water level in the bioreactor, which is a feature of continuous systems.

The advantage of the invention's solution is the simplicity of the construction without moving parts, and therefore increased reliability of the treatment plant. Another advantage is that the operation of the treatment plant can be controlled by a single float in the storage tank as well as by a sophisticated control unit. Compared to known SBR systems, the advantage lies in the fact that the bioreactor is aerated during the entire filling phase of the accumulation to the maximum depth of the bioreactor, which results in better energy use of oxygen from the supplied air. The most significant advantage, on which the other advantages described above are based, is the simple construction of the decanting device consisting of, for example, an air pump, and the trouble-free provision of the required water quality. Thanks to the simplicity of the technical solution, the technology is also very suitable for the reconstruction of old or even new problematic domestic wastewater treatment plants. The simplicity of its design makes it particularly suitable for small domestic cleaning plants.

### BRIEF DESCRIPTION OF DRAWINGS

FIG. 1 shows a plan view of a design of a domestic wastewater treatment plant comprising two circular tanks.

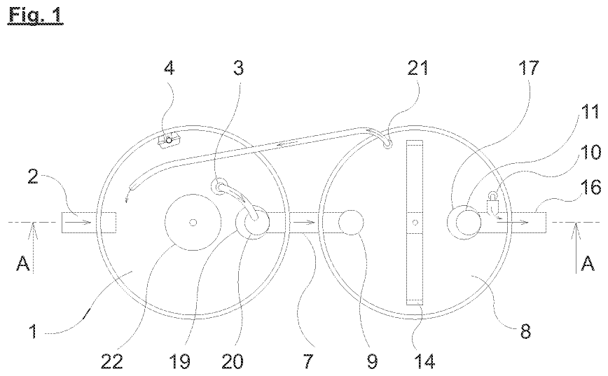

FIG. 2 shows a rectangular-shaped treatment plant.

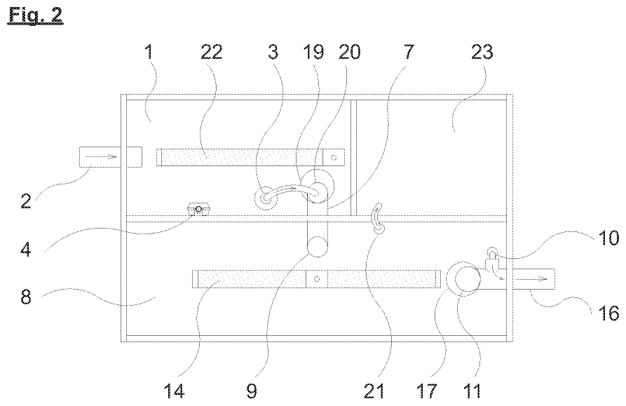

FIG. 3 shows an A-A section of the treatment plant as shown in FIG. 1 during the bioreactor filling stage.

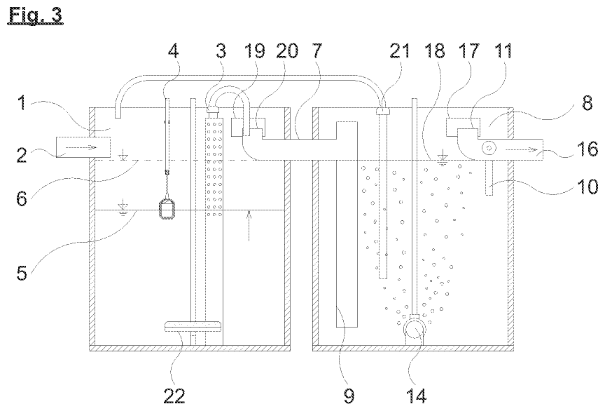

FIG. 4 shows the A-A section for the sedimentation phase.

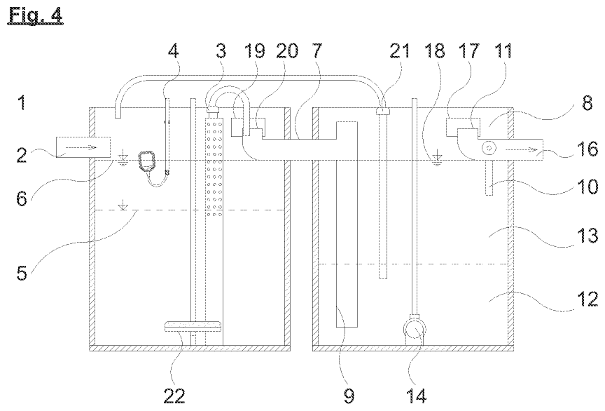

FIG. 5 shows the A-A section for the discharge phase.

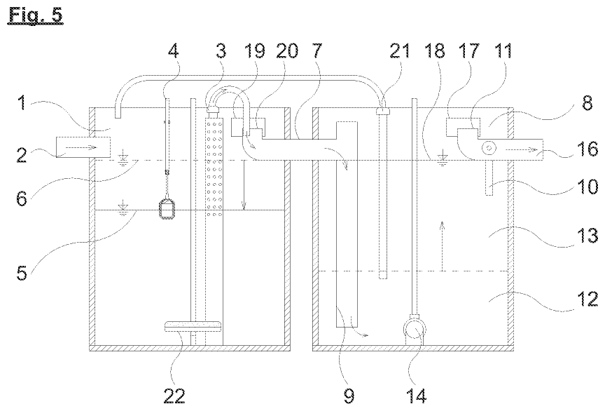

### DETAILED DESCRIPTION

Referring to the figures, wastewater flows into the inflow storage tank 1 via inflow 2. The level of wastewater in the storage tank 1 rises from a minimum level 5 to a maximum level 6, and these levels are detected by a measuring device 4 comprising, for example, a float, a pressure probe, ultrasound or other detection devices. The bioreactor 8 is filled by the wastewater pump 3 to the water level 18 and is aerated by the aeration system 14. At this stage of the cleaning process it is also advisable to aerate the storage tank 1 with the aeration system 22. When the maximum level 6 in the storage tank 1 is reached, the aeration of the bioreactor 8 ceases and the sedimentation phase occurs, whereby the sludge in the bioreactor 8 settles at the bottom and subsequently forms a layer of sludge 12, which separates from the layer of treated water 13. After the time necessary for sedimentation, which is usually more than 20 minutes, the discharge phase begins with the start-up of the treated water pump 10 in the bioreactor 8 and the wastewater pump 3, which pumps the wastewater from the storage tank 1 to the connection pipe 7 and then via the vertical pipe 9 to the bottom of the reactor 8. The water level in storage tank 1 gradually drops to the minimum level 5. The pumped wastewater displaces the already purified water to the treated water pump 10, thereby replacing the already pumped purified water from the bioreactor 8 and maintaining a stable internal water level 18, as advantageously for the treated water pump 10, throughout the pumping process. The treated water is pumped from the subsurface water layer in the bioreactor 8 by the treated water pump 10 to the drain 16. In the case of a larger inflow from the storage tank 1, the treated water also flows out through the safety overflow 11, which is equipped with a pre-set boom 17. This prevents impurities floating on the surface of the water in the bioreactor 8 from leaking into the already treated water. The treated water pump 10 usually comprises an air-lift pump, as does the wastewater pump 3. The water level 18 in the bioreactor 8 is maintained at a constant level during the discharge phase, or fluctuates slightly within the safety overflow level 11. The water level 18 in the reactor 8 must be reduced to below the safety overflow level 11 before the discharge phase is completed and the next filling phase begins.

After the sedimentation phase is completed and before the next filling phase, the reactor 8 is usually decanted by the sludge pump 21 into the accumulation tank 1, or into a separate sludge tank 23.

In the event of a larger wastewater inflow, the storage tank 1 is equipped with a safety overflow 20. A pre-set boom 19 is placed in front of the safety overflow 20, if it is used, in order to prevent coarse dirt from entering the bioreactor 8.

What is claimed is:

1. A method of treating wastewater with activated sludge in domestic wastewater treatment plants, comprising:
filling a storage tank with wastewater until a maximum level is reached and aerating a bioreactor while the storage tank is being filled;
after subsequent sedimentation of activated sludge at a bottom of the bioreactor, pumping treated water from a subsurface water layer in the bioreactor while simultaneously feeding wastewater from the storage tank into a settled sludge layer in the bioreactor to maintain a constant water level in the bioreactor until a level of wastewater in the storage tank reaches a minimum level; and
when the level of wastewater in the storage tank reaches the minimum level, resuming the filling of the storage tank with wastewater and the aeration of the bioreactor.

2. A method of treating wastewater with activated sludge according to claim 1, further comprising aerating the wastewater in the storage tank during the aeration of the bioreactor.

3. A domestic biological wastewater treatment plant comprising:
a storage tank (1) having a wastewater inflow (2), a wastewater pump (3), and a measuring device (4) for detecting a minimum level (5) of wastewater and a maximum level (6) of wastewater;
a bioreactor (8) coupled to the wastewater pump (3) and having an aeration device (14), a treated water drain (16), a safety overflow (11) coupled to the treated water drain (16), and a pump (10) for the treated water coupled to the treated water drain (16) for pumping the treated water out of the treatment plant;
wherein the storage tank (1) further comprises a safety overflow (20) coupled to a bottom of the bioreactor (8) via a connecting pipe (7) connected to a vertical pipe (9); and
wherein the hydraulic power of the wastewater pump (3) and the treated water pump (10) are sized to maintain a stable level (18) in the bioreactor (8).

4. A domestic biological wastewater treatment plant according to claim 3, further comprising a sludge tank (23).

5. A domestic biological wastewater treatment plant according to claim 3, wherein the storage tank (1) is equipped with an aeration device (22).

6. A domestic biological wastewater treatment plant according to claim 3, wherein the bioreactor (8) comprises a sludge pump (21) discharging into a sludge tank (23).

7. A domestic biological wastewater treatment plant according to claim 3, wherein the bioreactor (8) comprises a sludge pump (21) discharging into a storage tank (1).
